(19) United States
(12) Patent Application Publication
(10) Pub. No.: US 2007/0146959 A1
(43) Pub. Date: Jun. 28, 2007

(54) Relay drive circuit

(75) Inventor: Manabu Morita, Anjo-city (JP)

Correspondence Address: POSZ LAW GROUP, PLC, 12040 SOUTH LAKES DRIVE, SUITE 101, RESTON, VA, 20191, US

(73) Assignee: ANDEN CO., LTD., Anjo-city (JP)

(21) Appl. No.: 11/638,365

(22) Filed: Dec. 14, 2006

(30) Foreign Application Priority Data
Dec. 28, 2005 (JP) 2005-378166
Sep. 26, 2006 (JP) 2006-260573

(51) Int. Cl. H01H 47/00

(52) U.S. Cl. 361/160

(57) ABSTRACT

A potential of an end of the coil is inputted to a plate-OFF detecting portion which detects OFF-tendency in which a plate of a relay is about to get apart from a head of a core of the relay. When the OFF-tendency is detected, a coil current for supplying a coil of the relay is set to a first current value with which a plate of an electromagnetic relay is drawn and a movable contact of the relay comes in contact with a fixed contact of the relay. When an external disturbance ends, the coil current is returned to a second current value, which is smaller than the first current value, so that the movable contact and the fixed contact are kept in contact with each other.

### CROSS REFERENCE TO RELATED APPLICATION

This application is based on and incorporates herein by reference Japanese patent applications No. 2005-378166 filed on Dec. 28, 2005 and No. 2006-260573 filed on Sep. 26, 2006.

### FIELD OF THE INVENTION

The present invention relates to a relay drive circuit for controlling ON and OFF states of an electromagnetic relay provided in a line for supplying electric power of a power source.

### BACKGROUND OF THE INVENTION

In an electromagnetic relay, a sudden external disturbance such as an external shock sometimes causes an electrical connection in the relay to become off. For example, an external disturbance detaches a plate (, or an armature) from a coil of the relay and accordingly turns the relay to OFF.

In JP 2005-50733A, an art is proposed which regains the ON state of the relay by supplying electric power to the coil on detecting that the relay is turned to OFF.

However, since the conventional art regains the ON state after the relay gets to the OFF state, the conventional art cannot prevent it from occurring that the relay is temporality turned to OFF and power supply from the relay to a load is accordingly cut off.

In view of this, another conventional art supplies the coil with a holding current which has such excessive a current value that the external disturbance cannot detach the plate from the coil. With this conventional art, the relay is not turned to OFF because of some external disturbance resulting from certain usages of the relay and steady external disturbances resulting from degradation of the relay.

In this conventional art, the relay consumes much power because it is supplied with the holding current acting as a measure against the external disturbance even if the external disturbance is not occurring. In addition, the relay and a relay drive circuit produce much heat, which may harm a primary purpose of the relay and the relay drive circuit to reduce an amount of heat produced by the relay and the relay drive.

### SUMMARY OF THE INVENTION

It is therefore an object of the present invention to provide a relay drive circuit which suppresses power consumption and also reduces a possibility that the external disturbance turns the relay to OFF.

A relay drive circuit according to an aspect of the present invention includes a first drive portion, a second drive portion, a current switching portion, and a plate-OFF detecting portion. The first drive portion sets a coil current to be supplied to a coil to a first current value with which a plate of an electromagnetic relay is drawn and a movable contact of the relay comes in contact with a fixed contact of the relay.

The second drive portion sets the coil current to a second current value which is smaller than the first current value set by the first drive portion, so that the movable contact and the fixed contact are kept in contact with each other.

The current switching portion between supplying the coil with the coil current having the first current value set by the first drive portion and supplying the coil with the coil current having the second current value set by the second drive portion.

The plate-OFF detecting portion detects, based on change of a potential at an end of the coil, OFF-tendency in which the plate is about to get apart from a head of a core of the relay.

In addition, the current switching portion switches to supplying the coil with the coil current having the first current value set by the first drive portion, when the plate-OFF detecting portion detects the OFF-tendency.

As described above, when the plate-OFF detecting portion detects the OFF-tendency, the coil current is set to the first current value before the movable contact gets apart from the fixed contact. Thus, the coil is supplied with the coil current having the first current value. Therefore, although the relay drive circuit can prevent the sudden external disturbance from occurring, it is not necessary to keep supplying the coil 4a with a current having a value acting as a measure against the external disturbance while the external disturbance is not occurring.

Therefore, the relay drive circuit can prevent the relay from turning to OFF caused by the sudden external disturbance, without necessity of keeping supplying the coil with a current having a value acting as a measure against the external disturbance even while the external disturbance is not occurring. Therefore, the relay drive circuit can reduce the possibility that the relay is turned to OFF by the external disturbance, and can suppress the power consumption.

For example, in the case that the current switching portion is located at a low-side of the relay and drives the relay through the low-side, the plate-OFF detecting portion may detect the OFF-tendency based on change of a potential at the low-side of the coil. The low-side is one of two ends of the coil having lower potential than the other one of the two ends. In this case, the plate-OFF detecting portion may include a highpass filter for passing only high frequency components in the potential at the low-side of the coil, and the plate-OFF detecting portion may detect the OFF-tendency when change of the high frequency components is larger than a threshold.

In contrast, in the case that the current switching portion is located at a high-side of the relay and drives the relay through the high-side, the plate-OFF detecting portion may detect the OFF-tendency based on change of a potential at the high-side of the coil. The high-side is one of two ends of the coil having higher potential than the other one of the two ends. In this case, a capacitor serving as a highpass filter can be disused since the potential at the high-side of the coil does not sensitively change according to the change of a power source.

In another aspect of the present invention, the drive circuit includes an optimum current setting portion for controlling the current switching portion so that the second current value becomes optimal. In addition, the optimum current setting portion sets, when the plate-OFF detecting portion detects the OFF-tendency while the coil current with the second current value is being supplied to the coil, a new value as the second current value which is larger than an old value set as the second current value before detection the OFF-tendency.

A value which the second current value takes when the OFF tendency is detected corresponds to a required current value which is the minimum value to keep the plate from being pulled apart from the head of the core. It is thus possible to watch the required current value without a specially made sensor. By setting the second current value again to a value larger than the required current value, the second current value becomes optimal.

Therefore, the relay drive circuit can prevent the relay from turning to OFF caused by the regular (or constant) external disturbance, without necessity of keeping supplying the coil with a current having a value acting as a measure against the external disturbance even while the external disturbance is not occurring. Therefore, the relay drive circuit can reduce the possibility that the relay is turned to OFF by the external disturbance and can suppress the power consumption.

For example, the first drive portion may set, when the relay switch is turned to ON, the coil current to the first current value so as to draw the plate so that the movable contact comes in contact with the fixed contact. The optimum current setting portion may subsequently decrease a current value of the coil current gradually from the first current value. The optimum current setting portion may set, on detecting the OFF-tendency in decreasing the current value of the coil current, the new value as the second current value which is larger than a certain value being the second current value at the detection the OFF-tendency.

The first drive portion may set, when the plate-OFF detecting portion detects the OFF-tendency, the coil current to the first current value so as to draw the plate so that the movable contact comes in contact with the fixed contact. The optimum current setting portion may subsequently decrease a current value of the coil current gradually from the first current value. The optimum current setting portion may set, on detecting the OFF-tendency in decreasing the current value of the coil current, the new value as the second current value which is larger than the old value set as the second current value before the detection the OFF-tendency.

In the case that the coil current is decreased to the second current value immediately after the transition to a first state for supplying the first current value to the coil, the relay drive circuit works well if the required current value does not change in the first state. However, if the required current value changes in the first state, the second current value may be exceeded by the changed required current value when the relay drive circuit decrease the coil current to the second current value. By gradually decreasing the coil current from the first current value to the second current value, it is possible to set again a new second current value according to the changed required current value, even if the required current value changes.

For example, the optimum current setting portion may include a D/A converter for generating a potential corresponding to a counter value and an optimum current control portion for counting the counter value. In this case, the relay drive circuit may change the potential outputted by the D/A converter by changing the counter value of the optimum current control portion so as to decrease the current value of the coil current gradually from the first current value.

Thus, it is possible to detect the required current value every time by using a counter to decrease gradually the coil current after supplying, every time when the plate-OFF detecting portion detects the OFF tendency, the coil with the coil current having first current value. It is therefore unnecessary to memorize in an EEPROM or the like a previously set value for the second current value.

In a likewise manner, the optimum current setting portion may include an optimum current control portion including a counter for counting a counter value. In this case, the current switching portion may include a constant current D/A converter for executing weighting based on the counter value so as to change a value of a current to output. In addition, the relay drive circuit may change the value of the current outputted by the constant current D/A converter by changing the counter value of the optimum current control portion so as to decrease the current value of the coil current gradually from the first current value. An effect similar to the above is attained with this operation.

It is possible to construct an electric connection box which gathers the relay drive circuit, the relay, a wiring member, and a case, wherein the case includes the wiring member and accommodates the relay drive circuit and the relay. Thus, it is possible to install the relay drive circuit and relay into the same electric connection box. In the case that the relay drive circuit and the relay are incorporated in the same box, it is easier to arrange wiring than in the case that the relay drive circuit and the relay are incorporated in separate boxes. Besides, in the case that the relay drive circuit and the relay are incorporated in the same box, it is not necessary to use wire harnesses.

### BRIEF DESCRIPTION OF THE DRAWINGS

The invention, together with additional objective, features and advantages thereof, will be best understood from the following description, the appended claims and the accompanying drawings. In the drawings:

FIG. 1 is a schematic diagram showing a circuit structure of a relay drive circuit according to a first embodiment of the present invention;

FIG. 2A is a side view of a detailed structure of an electromagnetic relay in an OFF state;

FIG. 2B is a side view of the detailed structure of the electromagnetic relay in an ON state;

FIG. 3 is a schematic diagram showing a circuit structure of a plate-OFF sensing portion of the relay drive circuit shown in FIG. 1;

FIG. 4 is a timing chart showing an example of the operation of the relay drive circuit;

FIG. 5 is a timing chart in a case where a sudden external disturbance occurs;

FIG. 6A is a timing chart in a case where an Ir required value does not change while an electric current Ir is being reduced from its maximum to a holding current;

FIG. 6B is a timing chart in a case where the Ir required value changes while the electric current Ir is being reduced from its maximum to the holding current;

FIG. 7 is a schematic top view of an electric connection box;

FIG. 8 is a cross sectional view of the electric connection box taken along the line VII-VII in FIG. 7;

FIG. 9 is a schematic circuit diagram showing a relay drive circuit according to a fourth embodiment of the present invention;

FIG. 10 is a schematic diagram showing a circuit structure of a plate-OFF sensing portion of the relay drive circuit shown in FIG. 9; and

FIG. 11 is a schematic circuit diagram showing a relay drive circuit according to a fifth embodiment of the present invention.

### DETAILED DESCRIPTION OF THE EMBODIMENTS

Embodiments of the present invention will be described with reference to the drawings. In the drawings, a common reference number is given to portions in different embodiments if the portions are identical or almost identical to each other.

### First Embodiment

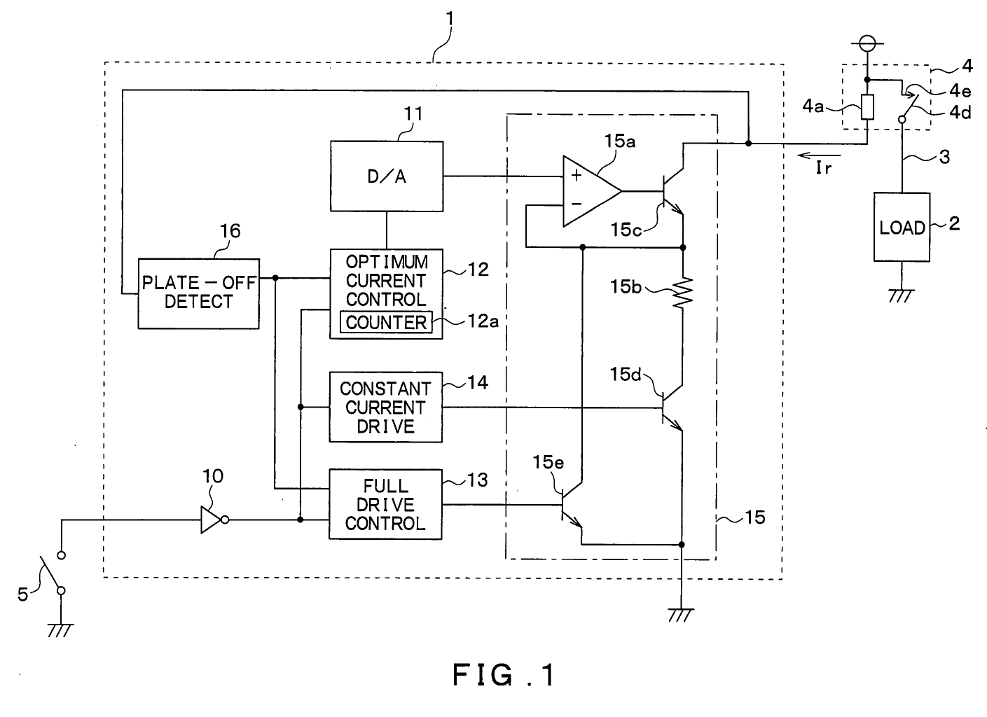

Hereinafter, a structure of a relay drive circuit 1 according to a first embodiment of the present invention is described with reference to FIG. 1.

As shown in FIG. 1, an electromagnetic relay 4 is provided which turns on and off power supply to a load 2 through a power supply line 3. The relay drive circuit 1 is for controlling power supply to a coil 4a which is included by the relay 4. The relay drive circuit 1 is connected with an end of the relay 4. More specifically, the relay drive circuit 1 is located at the low-side of the relay 4 and drives relay 4 from the low-side.

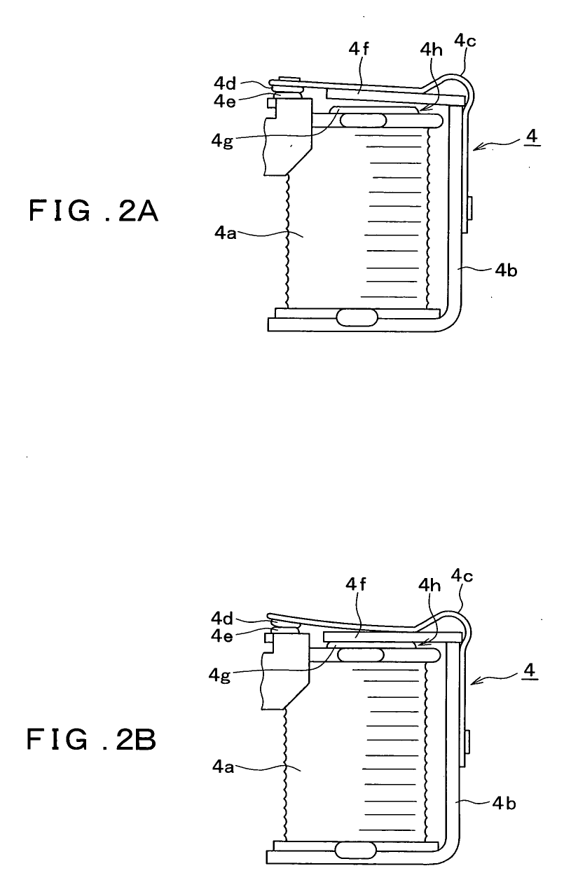

FIGS. 2A and 2B are side views of a detailed structure of the relay 4 in OFF and ON state, respectively.

As shown in FIGS. 2A and 2B, the relay 4 includes the coil 4a, a yoke portion 4b, a plate spring 4c, a movable contact 4d, a fixed contact 4e, a plate 4f, and a core 4h. The core 4h includes a core head 4g at its head end. The yoke portion 4b bears the coil 4a. The plate spring 4c is fixed at its base end to a top surface (, or a vertical surface) of the yoke portion 4b. The movable contact 4d is attached to a surface of a head end portion of the plate spring 4c. The fixed contact 4e is attached to a lateral end portion of the coil 4a and faces the movable contact 4d. The plate 4f is composed of magnetic material and is attached to a surface of a middle portion of the plate spring 4c. The core 4h is inserted in the coil 4a and faces the plate 4f.

When the power supply to the coil 4a is shut, an elastic force of the plate spring 4c draws the plate 4f apart from the core head portion 4g, as shown in FIG. 2A. The movable contact 4d subsequently gets apart from the fixed contact 4e and the relay 4 is turned to OFF. When electrical power is supplied to the coil 4a, the plate 4f is drawn to come in contact with the core head portion 4g, as shown in FIG. 2B, because a magnetic attracting force of the coil 4a becomes stronger than the elastic force of the plate spring 4c. The movable contact 4d accordingly comes in contact with the fixed contact 4e and the relay 4 is turned ON.

The relay drive circuit 1 controls operation of the relay 4 and also reduces a possibility that the relay 4 is turned to OFF even if the plate 4f starts to be drawn apart from the core head portion 4g because of an external disturbance.

More specifically, the relay drive circuit 1 includes, as shown in FIG. 1, a NOT circuit 10, a D/A converter 11, an optimum current control portion 12, a full drive control portion 13, a constant current drive portion 14, a current switching circuit portion 15, and a plate-OFF detecting portion 16.

The NOT circuit 10 inverts the electrical potential of the ground (i.e. Low) to Hi and apply the Hi electrical potential to the optimum current control portion 12, the full drive control portion 13, and the constant current drive portion 14, when a relay switch 5 is pressed by a user.

The D/A converter 11 and the optimum current control portion 12 serve as an example of an optimum current setting portion of the present invention.

The D/A converter 11 outputs a reference voltage to an operational amplifier 15a described later. The D/A converter 11 can change the value of the reference voltage within a range, for example, from 0V to 5V. An amount of a holding current used to maintain an ON state of the relay 4 changes according to the reference voltage outputted by the D/A converter 11.

The optimum current control portion 12 sets a value for the reference voltage outputted by the D/A converter 11 so that a coil current Ir to be supplied to the coil 4a achieves an optimally controlled current amount. For example, the optimum current control portion 12 may include a counter 12a and output to the D/A converter 11 a control signal indicating a counter value stored by the counter 12a. The counter value of the counter 12a is for controlling the reference voltage outputted by the D/A converter 11 and therefore corresponds to the voltage value of the reference voltage. When the optimum current control portion 12 outputs the control signal, the D/A converter 11 outputs the reference potential having the voltage value which corresponds to the counter value indicated by the control signal.

When the plate-OFF detecting portion 16 detects OFF-tendency in which the plate 4f is about to be drawn apart from the core head portion 4g, the optimum current control portion 12 receives from the plate-OFF detecting portion 16 a signal indicating the OFF-tendency. The optimum current control portion 12 then stores at this time the counter value of the counter 12a and thereafter outputs to the D/A converter 11 the control signal indicating the counter value having a value larger than the stored value by two. Thus, the optimum current control portion 12 makes the D/A converter 11 increase the value of the reference voltage compared to that before detecting the OFF-tendency so that the amount of the holding current to the coil 4a becomes larger.

Each of the D/A converter 11 and the optimum current control portion 12 may be constructed by, for example, a single microcomputer.

The full drive control portion 13 serves as an example of a first drive portion. The full drive control portion 13 controls, in turning the relay 4 from OFF to ON, the current switching circuit portion 15 so that the coil 4a is supplied, for a predetermined fixed period, from a power source with the coil current Ir having the maximum current value (, or a full supply current value). The maximum current value is an example of a first current value. More specifically, when the user operates the relay switch 5 to turn the relay 4 from OFF to ON, the Hi potential is applied through the NOT circuit 10 to the full drive control portion 13. The full drive control portion 13 then detects that the potential at its terminal connected with the NOT circuit 10 is switched to Hi and accordingly outputs the Hi potential for the fixed period to the current switching circuit portion 15.

The full drive control portion 13 controls, when the external disturbance occurs and the relay 4 is about to be turned from ON to OFF, the current switching circuit portion 15 so that the coil 4a is supplied from a power source with the coil current Ir having the maximum current value. More specifically, when the plate-OFF detecting portion 16 detects the OFF-tendency, the potential outputted by the plate-OFF detecting portion 16 is switched to Low as described later. The full drive control portion 13 then detects that the potential at its another terminal connected to the plate-OFF detecting portion 16 is switched to Low and accordingly outputs the Hi potential for the fixed period to the current switching circuit portion 15.

The constant current drive portion 14 serves as an example of a second drive portion. The constant current drive portion 14 controls, in maintaining the ON state of the relay 4, the current switching circuit portion 15 so that the coil 4a is supplied with a holding current as the coil current Ir. The holding current is set to have a current value smaller than the maximum current value. The coil current Ir can be the holding current in this case because a current value required to maintain the ON state of the relay 4 is relatively small. More specifically, when the user operates the relay switch 5 to turn the relay 4 from OFF to ON, the Hi potential is applied through the NOT circuit 10 to the constant current drive portion 14. The constant current drive portion 14 then detects that the potential at its terminal connected with the NOT circuit 10 is switched to Hi and thereafter outputs the Hi potential constantly to the current switching circuit portion 15.

The current switching circuit portion 15 serves as an example of a current switching portion and switches between supplying the coil 4a with the coil current Ir with the maximum current value and supplying the coil 4a with the holding current. The current switching circuit portion 15 is located to the low-side of the relay 4. More specifically, the current switching circuit portion 15 includes an operational amplifier 15a, a resistor 15b, and first to third transistors 15c to 15e.

The operational amplifier 15a installed so that its non-inverting input terminal receives the output voltage (i.e. the reference voltage) of the D/A converter 11, its inverting input terminal receives a potential from the emitter terminal of the first transistor 15c, and from its output terminal the base current of the first transistor 15c is outputted.

The resistor 15b has a fixed resistance value and is for reducing the amount of the coil current Ir to be supplied from a power source to the coil 4a of the relay 4.

The first transistor 15c having a collector terminal connected with a terminal of the coil 4a is used for controlling the coil current Ir to be supplied to the coil 4a.

The second and third transistors 15d and 15e are driven by the constant current drive portion 14 and the full drive control portion 13, respectively. The second transistor 15d is turned to ON when the constant current drive portion 14 outputs the Hi potential. The third transistor 15e is turned to ON when the full drive control portion 13 outputs the Hi potential. When the second transistor 15d is in the ON state and the third transistor 15e is in the OFF state, the coil current Ir is supplied through the resistor 15b and the coil 4a is therefore supplied with the holding current having the current value (which is an example of the second current value) smaller than the maximum current value. When the second transistor 15d is in the ON (or OFF) state and the third transistor 15e is in the ON state, the coil current Ir is supplied bypassing the resistor 15b and the coil 4a is therefore supplied with the coil current Ir having the maximum current value.

Since the reference voltage from the D/A converter 11 is changeable, the base current for the first transistor 15c is controlled so that the emitter potential of the first transistor 15c becomes closer to the reference voltage. Thus, the collector current for the first transistor 15c, that is, the electrical coil current Ir supplied to the coil 4a, is adjusted to have an optimum current value.

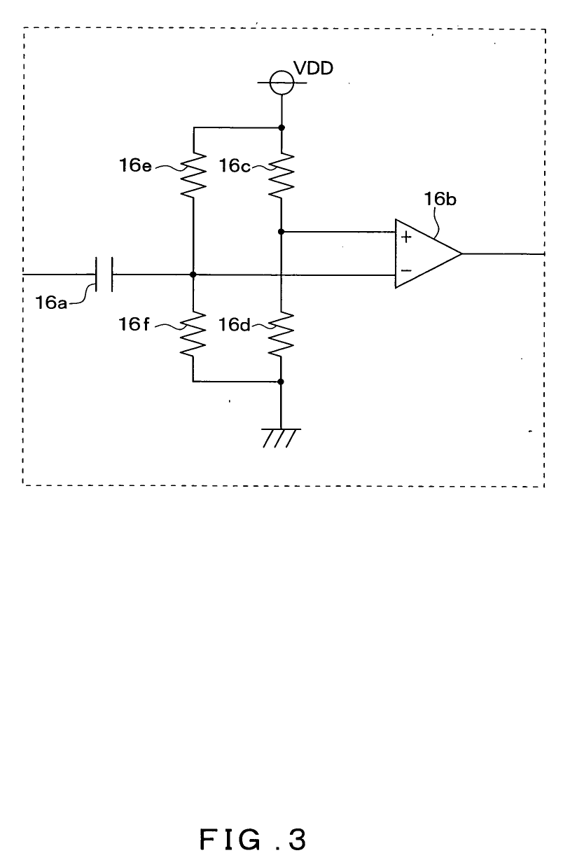

The plate-OFF detecting portion 16 senses a potential of a terminal (more specifically, the low-side terminal) of the coil 4a and detects the OFF-tendency based on the sensed potential. On detecting the OFF-tendency, the plate-OFF detecting portion 16 notifies the optimum current control portion 12 and the full drive control portion 13 of the detection of the OFF-tendency before the plate 4f gets apart from the core head portion 4g. More specifically, the plate-OFF detecting portion 16 has a circuit structure shown in FIG. 3.

As shown in FIG. 3, the plate-OFF detecting portion 16 includes a capacitor 16a, comparator 16b, and resistors 16c to 16f. The resistors 16c and 16d together constitute a resistor voltage divider for setting a threshold potential. The resistors 16e and 16f together constitute another resistor voltage divider for producing an intermediate potential.

When the potential from the terminal of the coil 4a is applied to the plate-OFF detecting portion 16, the capacitor 16a plays a role to block the DC component of the potential and pass only an AC component (, or a high frequency component). The capacitor 16a also plays a role of a highpass filter, with which the plate-OFF detecting portion 16 does not sense the potential from the coil 4a if the change rate of the potential is smaller than a certain threshold rate and senses the potential if the change rate is larger than the threshold rate.

The resistor voltage divider 16c-16d and the resistor voltage divider 16e-16f perform voltage dividing of the voltage VDD from the constant-voltage source. The potential resulting from the voltage dividing of the resistor voltage divider 16c-16d is inputted to the non-inverting input terminal of the comparator 16b. The potential resulting from the voltage dividing of the resistor voltage divider 16e-16f is inputted to the inverting input terminal of the comparator 16b. The potential, which results from voltage dividing of the resistor voltage divider 16e-16f and is inputted to the inverting input terminal, is the intermediate potential which is added to the AC component coming through the capacitor 16a. The potential, which result from voltage dividing of the resistor voltage divider 16c-16d and inputted to the non-inverting input terminal, is the threshold potential.

The comparator 16b compares the threshold potential set by the resistor voltage divider 16c-16d with a changing potential and outputs a signal based on the result of the comparison. The changing potential is the sum of the intermediate potential (which is a potential at an intermediate point) and the AC component coming through the capacitor 16a (that is, a changing component of the potential at the end of the 4a). More specifically, the comparator 16b outputs the Low potential when the changing potential is higher than the threshold potential and outputs the Hi potential when the changing potential is lower than the threshold potential.

Thus, the plate-OFF detecting portion 16 uses the potential of a terminal of the coil 4a as a potential to sense and detects whether there is the OFF-tendency by comparing the threshold potential with the changing potential including the AC component of the sensed potential.

When the plate 4f is biased in the direction apart from the core head portion 4g, the inductance of the coil 4a changes. This significantly changes a current value (hereinafter referred to an Ir required value) of the coil current Ir which is necessary in order to prevent the plate 4f from getting apart from the core head portion 4g. This also changes the voltage between the both ends of the coil 4a. In view of this phenomenon, the plate-OFF detecting portion 16 is made to monitor the Ir required value for the coil 4a by using the low-side potential of the coil 4a (which corresponds to the voltage between both ends of the coil 4a) as the potential to sense and by detecting the OFF-tendency based on the sensed potential.

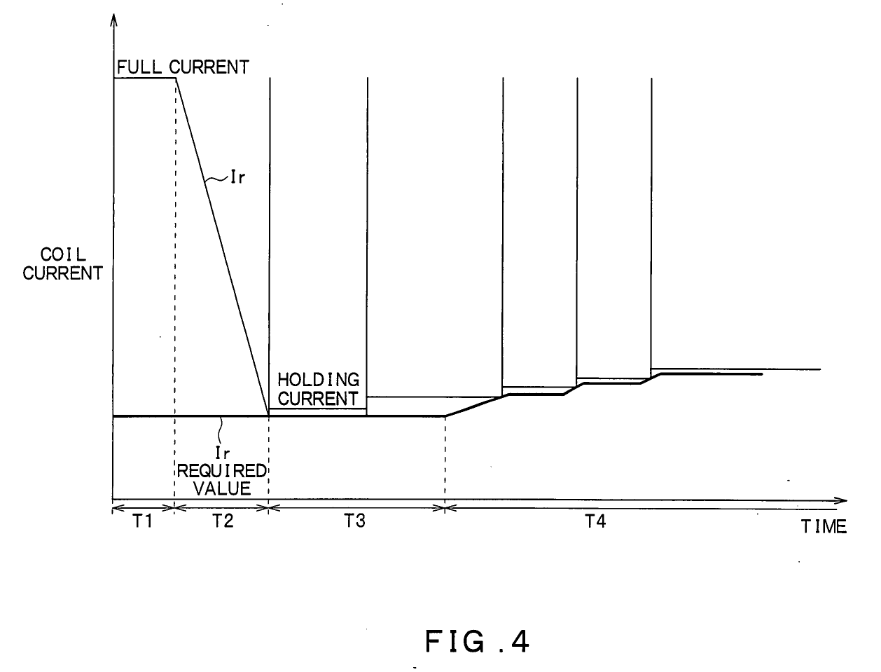

Hereinafter, an example of the operation of the relay drive circuit 1 according to the present embodiment will be described with reference to the timing chart in FIG. 4.

The Low potential is applied to the optimum current control portion 12, the full drive control portion 13, and the constant current drive portion 14 before a user presses the relay switch 5. Both the second transistor 15d and the third transistor 15e are hence in the OFF states and the coil current Ir is not supplied to the coil 4a of the relay 4. Therefore, the plate 4f is apart from the core head portion 4g, the movable contact 4d is apart from the fixed contact 4e, and the relay 4 is in the OFF state. Thus, power supply line 3 to the load 2 is in the OFF state and the load 2 is not supplied with the electric power.

When a user presses the relay switch 5, the Hi potential is applied through the NOT circuit 10 to the optimum current control portion 12, the full drive control portion 13, and the constant current drive portion 14. This makes the full drive control portion 13 and the constant current drive portion 14 output the Hi potential respectively to the third transistor 15e and the second transistor 15d, and the second and third transistors 15d and 15e turns to ON. At the same time, the optimum current control portion 12 outputs the control signal indicating a maximum counter value so that the reference potential outputted by the D/A converter 11 becomes the maximum value. Thus, the reference potential from the D/A converter 11 is set to the maximum value (for example, 5V). Accordingly, the relay drive circuit 1 gets into a full power supply state in which the coil current Ir for the coil 4a goes through the third transistor 15e and the value of the coil current Ir reaches at its maximum, as shown in a period T1 in FIG. 4.

Therefore, the magnetic attracting force of the coil 4a becomes more dominant than superior to the elastic force of the plate spring 4c, the plate 4f is pulled to come into contact with the core head portion 4g, the movable contact 4d comes into contact with the fixed contact 4e, and the relay 4 is turned to ON. The power supply line 3 is accordingly becomes ON and the load 2 starts being supplied with the electric power.

After a period, within which the relay 4 is supposed to have tuned to ON, a period T2 shown in FIG. 4 begins. At the start of the period T2, the potential outputted by the full drive control portion 13 is turned from Hi to Low, while the potential outputted by the constant current drive portion 14 is kept Hi. At the same time, the optimum current control portion 12 starts decreasing the counter value for outputting to the D/A converter 11 gradually from the maximum counter value. Therefore, the reference potential from the D/A converter 11 is gradually decreased, and the coil current Ir for the coil 4a is accordingly decreased gradually from an initial current value. The initial current value can be, for example, the maximum current value. In this process the plate-OFF detecting portion 16 does not detect the OFF-tendency even if the potential at the low-side of the relay 4 changes, because a change rate of the coil current Ir in this process is sufficiently smaller than a change rate of the coil current Ir in the external disturbance.

As the coil current Ir is decreased gradually, it approaches to the Ir required value. When the coil current Ir becomes equal to the Ir required value, the plate-OFF detecting portion 16 detects the OFF-tendency and changes the potential for outputting to the optimum current control portion 12 and full drive control portion 13 from Hi to Low.

The full drive control portion 13 accordingly detects the OFF-tendency and turns the third transistor 15e to ON in order to achieve the full power supply state for a constant period. The optimum current control portion 12 memorizes the counter value at the time of detection of the OFF-tendency and outputs to the D/A converter 11 the control signal indicating a value larger than the memorized counter value by, for example, two.

As described above, after the detection of the OFF-tendency the relay drive circuit 1 is in the full power supply state for a constant period in which the full drive control portion 13 operates to keep the coil current Ir at its maximum. After the constant period, the value of the reference voltage from the D/A converter 11 is set to a higher value than a value of the reference voltage at a time just before the OFF-tendency is detected. Therefore, after the constant period, the holding current is modified so that it has a certain margin. Thus, the relay drive circuit 1 transits from the full power supply state to a state in which the holding current supplied to the coil 4a.

Thus, the ON state of the relay 4 is maintained by the holding current to the coil 4a, the value of which is smaller than the maximum value and slightly larger than the Ir required value. Therefore, power consumption of the relay drive circuit 1 and relay 4 is suppressed.

Suppose that the sudden external disturbance occurs in a period T3 shown in FIG. 4, after the holding current is set. In this case, change of the inductance of the coil 4a causes the coil current Ir to change rapidly. The plate-OFF detecting portion 16 detects the change of the coil current Ir and switch the potential for outputting to the optimum current control portion 12 and the full drive control portion 13 from Hi to Low.

The full drive control portion 13 accordingly detects the OFF-tendency and turns the third transistor 15e to ON. In addition, the optimum current control portion 12 memorizes the counter value at the time of detection of the OFF-tendency and outputs to the D/A converter 11 the control signal indicating a value larger than the memorized counter value by, for example, two.

Similar to above, after the detection of the OFF-tendency the relay drive circuit 1 is in the full power supply state for a constant period in which the full drive control portion 13 operates to keep the coil current Ir at its maximum. After the constant period, the value of the reference voltage from the D/A converter 11 is set to a higher value than a value of the reference voltage at a time just before the OFF-tendency is detected. Therefore, after the constant period, the holding current is modified so that it has a new current value having a certain margin. Thus, even if the sudden external disturbance occurs, the relay drive circuit 1 can prevent the relay 4 from being turned to OFF by momentarily supplying the coil 4a with the coil current Ir having the maximum value.

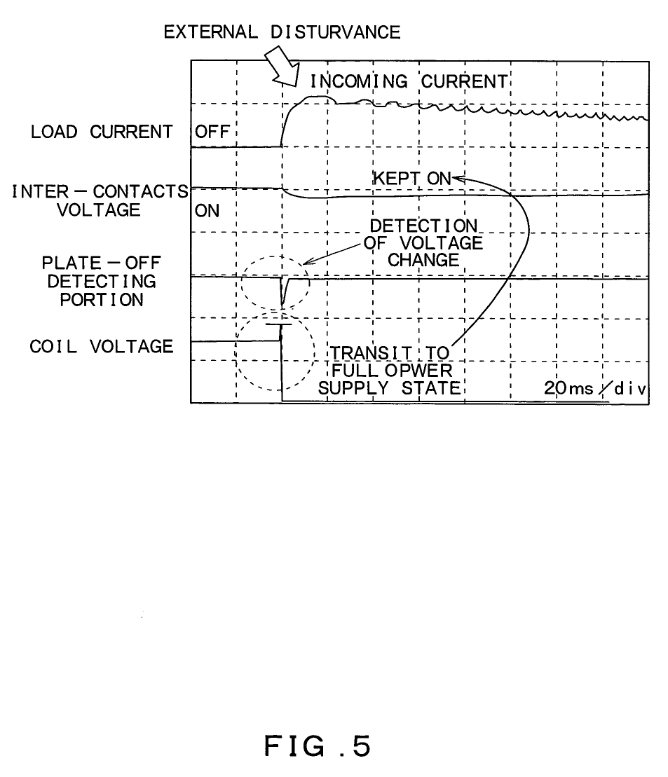

FIG. 5 is a timing chart showing electrical states of several portions of the relay drive circuit 1 and relay 4 in a period around the occurrence of the sudden external disturbance. As shown in FIG. 5, the inductance of the coil 4a changes and the voltage between both ends of the coil 4a accordingly changes when the sudden external disturbance (, or incoming current) occurs. At the moment, the potential outputted by the plate-OFF detecting portion 16 changes to Low, and the relay drive circuit 1 transits to the full power supply state.

After that, the plate-OFF detecting portion 16 detects the OFF-tendency again in a period T4 shown in FIG. 4, when a regular disturbance such as temperature variation changes the Ir required value to a value larger than the holding current at the time.

When the Ir required value changes and exceeds the holding current, the plate-OFF detecting portion 16 detects, in the same manner described in the case of the sudden external disturbance, the OFF-tendency and the switch the potential for outputting to the optimum current control portion 12 and the full drive control portion 13 from Hi to Low.

The full drive control portion 13 accordingly detects the OFF-tendency and turns the third transistor 15e to ON. In addition, the optimum current control portion 12 memorizes the counter value at the time of detection of the OFF-tendency and outputs to the D/A converter 11 a kind of the control signal indicating a value larger than the memorized counter value by, for example, two.

Similar to above, after the detection of the OFF-tendency the relay drive circuit 1 is in the full power supply state for a constant period in which the full drive control portion 13 operates to keep the coil current Ir at its maximum. After the constant period, the value of the reference voltage from the D/A converter 11 is set to a higher value than a value of the reference voltage at a time just before the OFF-tendency is detected. Therefore, after the constant period, the holding current is modified so that it has a new current value having a certain margin. Thus, a value is set to the holding current in the case that the Ir required value changes caused by the regular disturbance.

As described above, the relay drive circuit 1 according to the present embodiment transits to the full power supply state in which the relay drive circuit 1 momentarily maximizes the coil current Ir for supplying to the coil 4a when the sudden external disturbance occurs. In addition, the relay drive circuit 1 reduces the coil current Ir to the holding current when the sudden external disturbance ends. Therefore, the relay drive circuit 1 can prevent the relay 4 from turning to OFF caused by the sudden external disturbance, without necessity of keeping supplying the coil 4a with a current having a value acting as a measure against the external disturbance even while the external disturbance is not occurring.

Therefore, the relay drive circuit 1 can reduce the possibility that the relay 4 is turned to OFF by the external disturbance and suppress the power consumption.

In the relay drive circuit 1 of the present embodiment, the plate-OFF detecting portion 16 detects the Ir required value by monitoring the potential of the low-side of the coil 4a, and the optimum current control portion 12 adjusts the coil current Ir to a suitable value for the holding current based on the detected Ir required value. Therefore, the relay drive circuit 1 can prevent the regular external disturbance from wrongly turning the relay 4 to OFF while keeping the value of the holding current for maintaining the ON state of the relay 4 as small as possible. Thus it is possible to further suppress the power consumption.

### Second Embodiment

Hereinafter, the second embodiment of the present invention will be described. The relay drive circuit 1 of the present embodiment differs from the relay drive circuit 1 of the first embodiment in the operation of the relay drive circuit 1 after the plate-OFF detecting portion 16 detects the OFF-tendency and the relay drive circuit 1 transits to the full power supply state. The description below is only for a part of the present embodiment which differs from the first embodiment.

In the present embodiment, the relay drive circuit 1 does not immediately decrease, after the transition to the full power supply state, the coil current Ir to a new holding current having a new counter value larger by two than the old counter value corresponding to the old holding current just before the detection of the OFF-tendency. The relay drive circuit 1 according to the present embodiment decreases the coil current Ir gradually from an initial current value down to the new holding current after the transition to the full power supply state. The initial current value can be, for example, the maximum current value.

More specifically, the optimum current control portion 12 increases, on detecting the OFF-tendency, the counter value to be outputted to the D/A converter 11 to the maximum counter value and decreases after a constant period the counter value gradually from the maximum counter value to a new counter value larger by two than the old counter value corresponding to the old holding current just before the detection of the OFF-tendency.

In the case that the coil current Ir is decreased to the new holding current immediately after the transition to the full power supply state in which the coil current Ir is maximized, the relay drive circuit 1 works well if the Ir required value does not change in the full power supply state. However, if the Ir required value changes in the full power supply state, the new holding current may be exceeded by the changed Ir required value when the relay drive circuit 1 decreases the coil current Ir to the new holding current. By gradually decreasing the coil current Ir from its maximum to the new holding current, it is possible to set again a further new holding current according to the changed Ir required value, even if the required value changes.

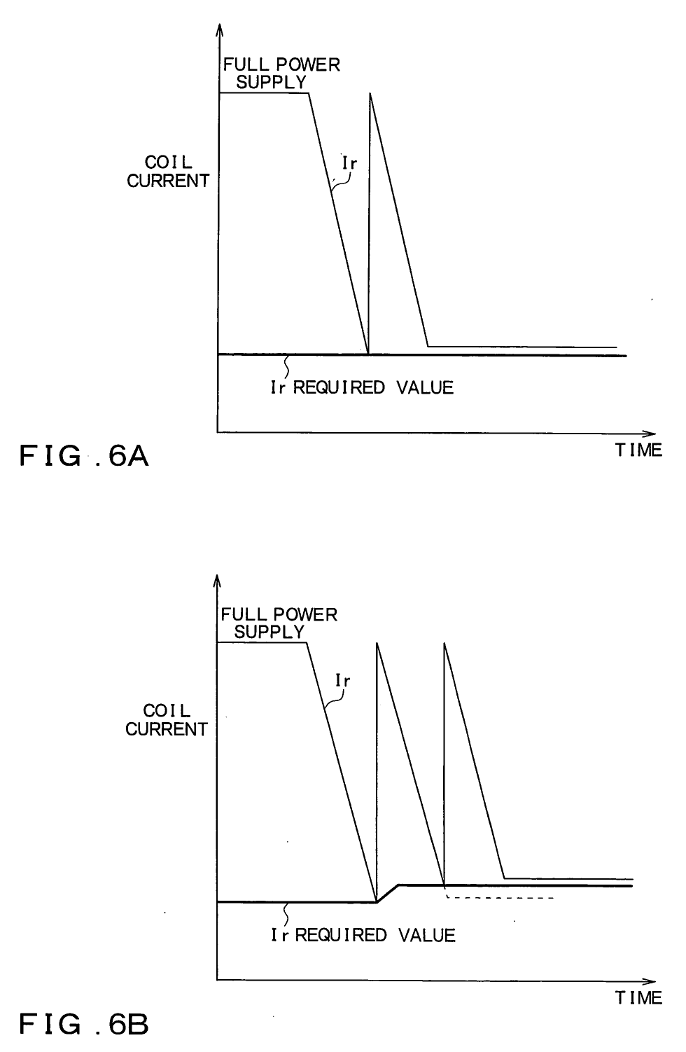

FIGS. 6A and 6B are timing charts showing examples of the change of the coil current Ir for the coil 4a in this embodiment. In the example shown in FIG. 6A, the Ir required value does not change while the coil current Ir is being reduced from its maximum to the holding current. In the example shown in FIG. 6B, the Ir required value changes while the coil current Ir is being reduced from its maximum to the holding current. As shown in these drawings, if the Ir required value does not change, the coil current Ir is decreased and kept to the new holding current corresponding to the new counter value larger by two than the old counter value of the counter 12a in the optimum current control portion 12 just before detecting the OFF-tendency. In contrast, if the Ir required value increases to exceed the new holding value, the further new holding value larger than the increased Ir required value is set again and therefore it is possible to prevent the change of the Ir required value wrongly turning the relay 4 to OFF.

### Third Embodiment

Hereinafter, the third embodiment of the present invention will be described. In the present embodiment an arrangement of the relay drive circuit 1, the relay 4, and an electric connection box in which the relay drive 25 circuit 1 and the relay 4 are incorporated differs from the first and second embodiments. The structures of the relay drive circuit 1 and the like are the same as those in the first and second embodiments. Only the configuration of the relay drive circuit 1, the relay 4, and the electric connection box is described below.

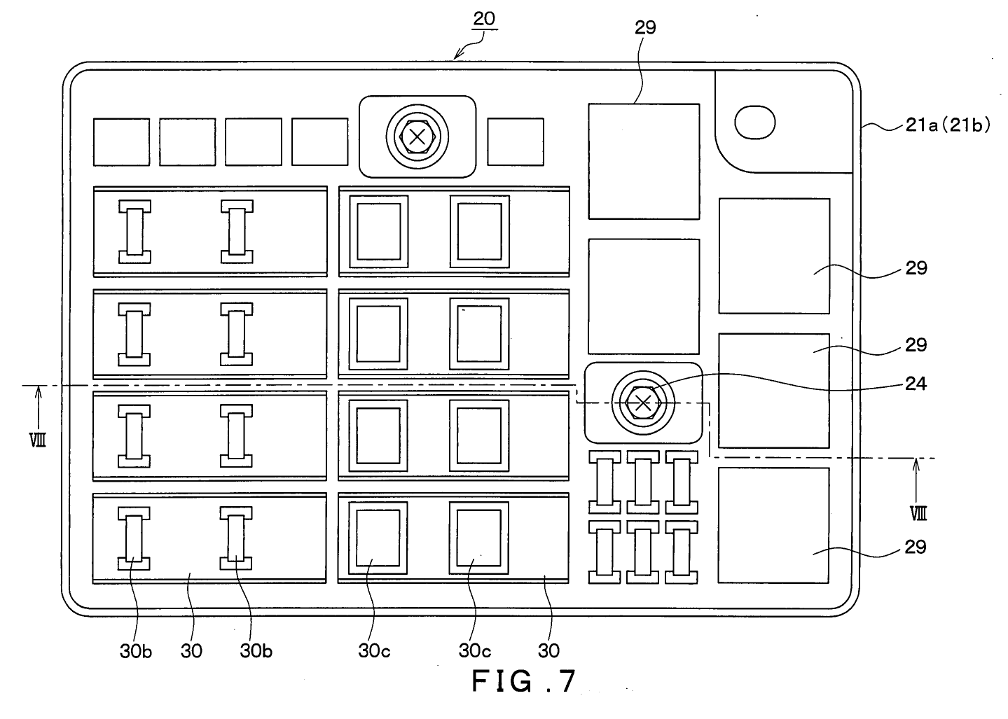

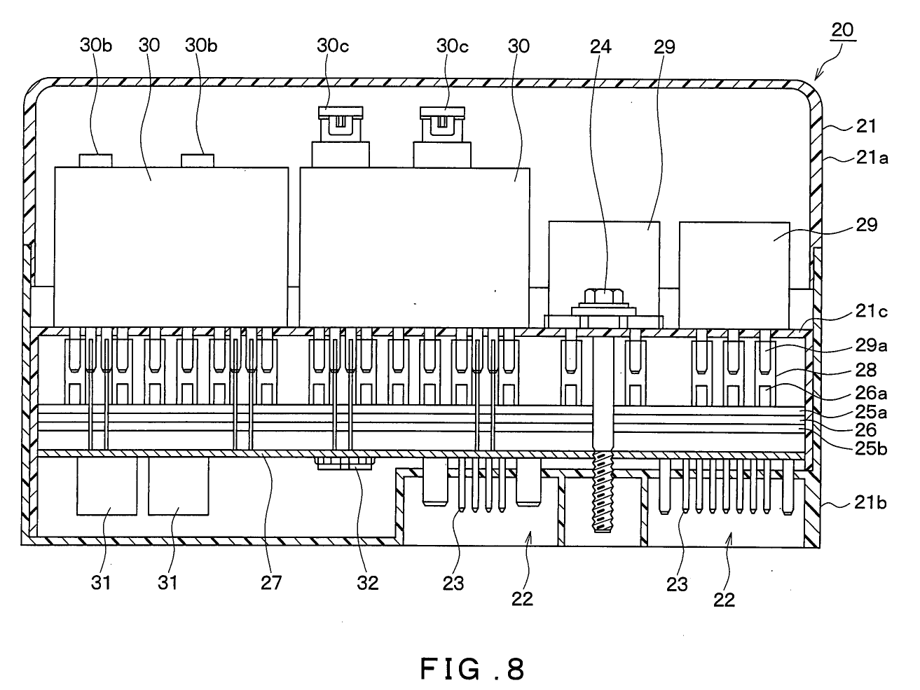

FIGS. 7 and 8 show the relay drive circuit 1, relay 4, and the electric connection box 20. More specifically, FIG. 7 is a schematic top view of the box 20 and FIG. 8 is a cross sectional view of the box 20 taken along the line VIII-VIII in FIG. 7.

As shown in the drawings, a case 21 of the box 20 includes an upper cover 21a, a lower cover 21b, and an inner cover 21c. The upper cover 21a and the lower cover 21b constitute an outer shape of the case 21 and respectively have practically U-shaped cross sections each with an open mouth. The upper cover 21a and the lower cover 21b are made so that an outer edge of the lower cover 21b at its open rim fits in an outer edge of the upper cover 21a at its open mouth. By arranging the upper cover 21a and the lower cover 21b so that the open mouths of them faces each other, and by fixing the upper cover 21a and the lower cover 21b so that the outer edge of the lower cover 21b at its open rim fits in the outer edge of the upper cover 21a at its open mouth. The upper cover 21a and the lower cover 21b form the outer shape of the case 21 as a single body.

An external connector portion 22 is located on a surface of the lower cover 21b opposite to another surface of the lower cover 21b facing the upper cover 21a. A plurality of connector terminals 23 are installed to the external connector portion.

The inner cover 21c is located at the inner side of the upper cover 21a and the lower cover 21b. The inner cover 21c is slightly smaller than the lower cover 21b and having a U-shaped cross section with an open mouth. By putting the inner cover 21c in the lower cover 21b and by rigidly fixing the inner cover 21c to the lower cover 21b with bolts, the inner cover 21c is fixed to the lower cover 21b.

In the inner cover 21c, a busbar substrate layer 26 is located between insulators 25a and 25b. In the inner cover 21c, a printed board layer 27 is also located in parallel with the busbar substrate layer 26. The busbar substrate layer 26 and the printed board layer 27 serve as a whole as an example of a wiring member.

A plurality of busbar terminals 26a extends from the busbar substrate layer 26, penetrating the insulator 25a. Each of the busbar terminals 26a is connected with each one of intermediating terminals 28. The inner cover 21c has a plurality of through holes each corresponding to each of the intermediating terminals 28. Each of terminals 29a of a plurality of plug-in relays 29 is connected through each of a part of the through holes with each of a part of the intermediating terminals 28. Each of terminals 30a of a plurality of twin relays 30 is connected through each of another part of the through holes with each of another part of the intermediating terminals 28. Each of the twin relays 30 includes two relays. Fuses 30b for use below 30 ampere or fusible links 30c for use above 30 ampere may be located on the upper surfaces of the twin relays 30 according to usage of the twin relays 30. They are used to protect the twin relays 30.

A plurality of relays 31 for the printed board 27 are located on the printed board layer 27. An IC chip 32 is also located on the printed board layer 27.

The IC chip 32 includes the relay drive circuit 1 according to the first or the second embodiment. Each of the relays 29, the twin relays 30, and the relays 31 can be to the relay 4 described in the first embodiment or the second embodiment.

Thus, it is possible to install the relay drive circuit 1 and relay 4 into the same electric connection box 20. In the case that the relay drive circuit 1 and the relay 4 are incorporated in the same box 20, it is easier to arrange wiring than in the case that the relay drive circuit 1 and the relay 4 are incorporated in separate boxes. Besides, in the case that the relay drive circuit 1 and the relay 4 are incorporated in the same box 20, it is not necessary to use wire harnesses.

### Fourth Embodiment

Hereinafter, a fourth embodiment of the present invention will be described. In the present embodiment, a relay drive circuit 1 having a structure very similar to the relay drive circuit 1 of the first embodiment is connected with the high-side of the relay 4. Therefore, the relay 4 is driven from the high-side in the present embodiment. Only the difference between the present embodiment and the first embodiment is described below.

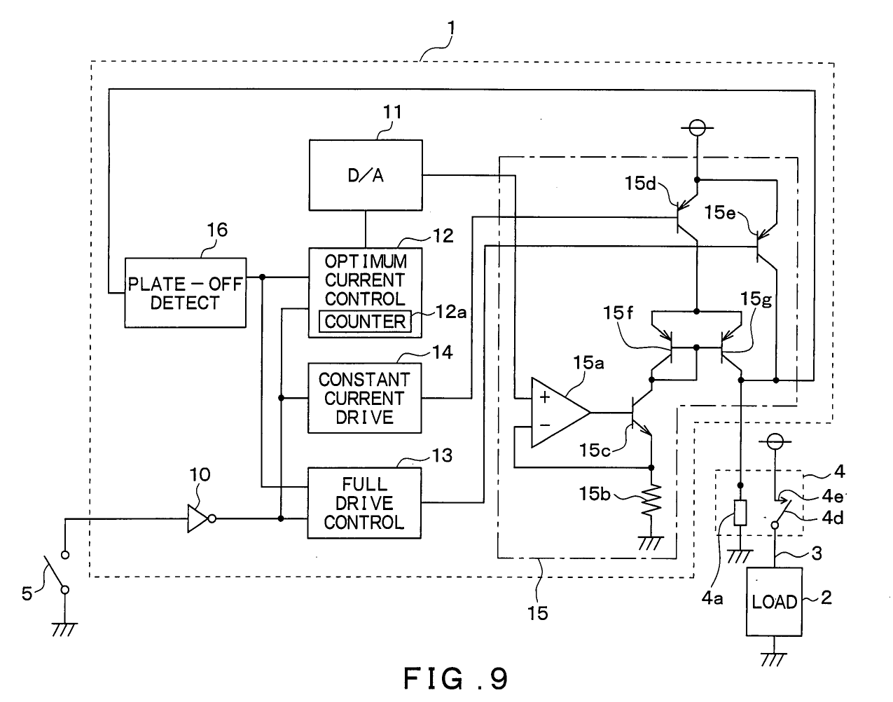

As shown in FIG. 9, which is a schematic diagram of the relay drive circuit 1 according to the present embodiment, the current switching circuit portion 15 includes a fourth transistor 15f and a fifth transistor 15g as well as the operational amplifier 15a, the resistor 15b, and the first to third transistors 15c to 15e. The fourth transistor 15f and the fifth transistor 15g constitute a current mirror circuit. The operation of the relay drive circuit 1 is basically the same with that of the relay drive circuit 1 of the first embodiment. More specifically, the operational amplifier 15a outputs from its output terminal the base current for the first transistor 15c when the non-inverting input terminal of the operational amplifier 15a receives the reference voltage outputted by the D/A converter 11 and the inverting input terminal of the operational amplifier 15a receives the emitter potential of the first transistor 15c. The first transistor 15c accordingly outputs the collector current based on the base current for the first transistor 15c. Then, a current is accordingly goes through the fourth transistor 15f, and a current based on a current mirror ratio of the current mirror circuit therefore goes through the fifth transistor 15g. The current at the fifth transistor 15g changes according to the counter value of the counter 12a of the optimum current control portion 12. Therefore, a current from the third transistor 15e driven by the full drive control portion 13 and the current from the fifth transistor 15g are supplied to the coil 4a, and the relay 4 is accordingly driven.

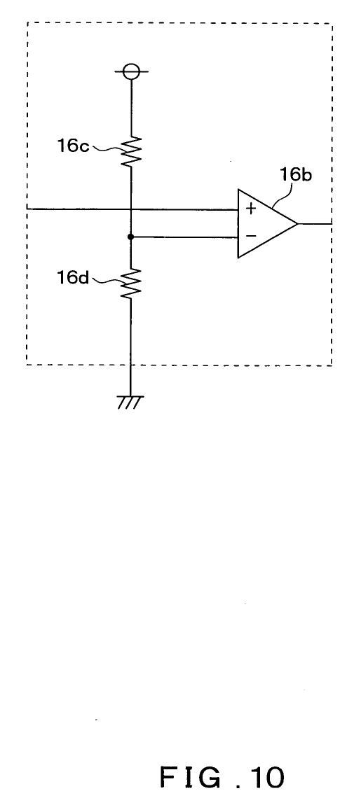

In the relay drive circuit 1 having the structure described above, the plate-OFF detecting portion 16 can detect the OFF-tendency based on the potential of the high-side of the coil 4a. The plate-OFF detecting portion 16 has a structure shown in FIG. 10.

As shown in FIG. 10, the plate-OFF detecting portion 16 of the present embodiment includes the comparator 16b, resistor 16c, and the resistor 16d. However, the plate-OFF detecting portion 16 does not have the capacitor 16a which is included by the relay drive circuit 1 of the first embodiment.

With this structure, the potential at the high-side of the coil 4a is detected as a difference of the high-side potential from the ground. Therefore, it is easy to measure a potential corresponding to the voltage between both ends of the coil 4a. In the case that the relay drive circuit 1 is located at the low-side of the relay 4, a battery voltage is directly applied to the coil 4a, and the potential at the low-side of the coil 4a sensitively changes according to the change of the battery voltage. Therefore the capacitor 16a which serves as a highpass filter is required in this case. In contrast, with the structure of the present embodiment, the capacitor 16a as a highpass filter can be disused since the potential at the high-side of the coil 4a does not sensitively change according to the change of the battery potential (power source).

### Fifth Embodiment

Hereafter, the fifth embodiment of the present invention will be described. A relay drive circuit 1 according to the present embodiment is based on the relay drive circuit 1 of the fourth embodiment which drives the relay 4 from the high-side of the relay 4 but differs in the structures of the D/A converter 11 and the current switching circuit portion 15. Only the difference between the relay drive circuit 1 of the present embodiment and the relay drive circuit 1 of the fourth embodiment will be described below.

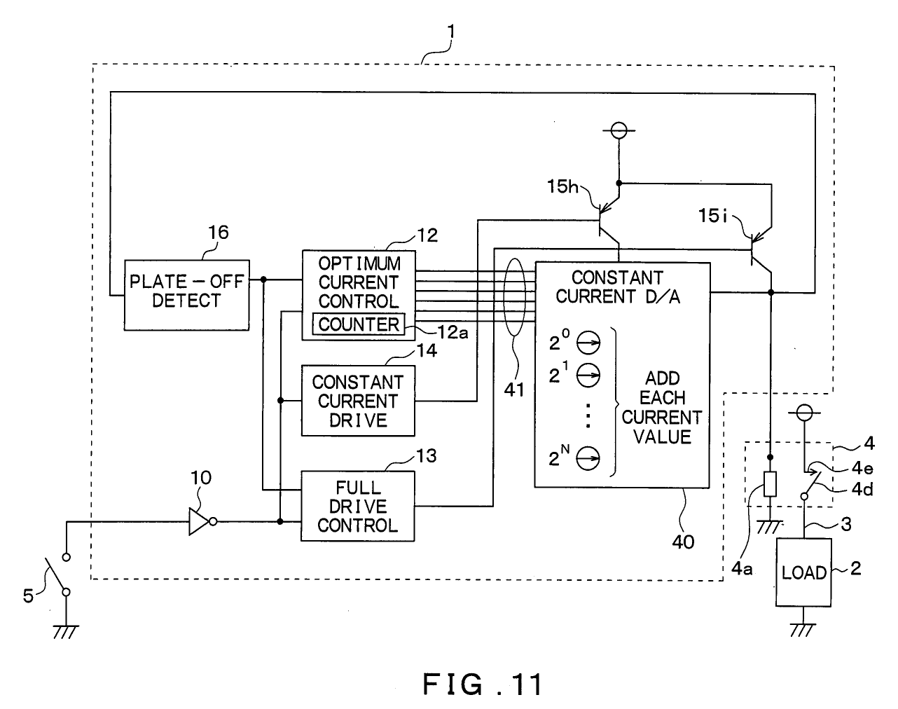

FIG. 11 is a schematic circuit diagram showing the relay drive circuit 1 according to the present embodiment. As shown in the drawing, the relay drive circuit 1 includes, in place of the D/A converter 11 in the fourth embodiment, a constant current D/A converter (or a weighting circuit) 40. The constant current D/A converter 40 is connected with the optimum current control portion 12 through data lines 41 for transmitting a plurality of bits at the same time. The optimum current control portion 12 outputs through the data lines 41 a data value consisting of the multiple bits, the data value corresponding to a current value at which the constant current D/A converter 40 should output a current. The constant current D/A converter 40 includes a plurality of constant current circuits each weighted by 2ⁿwherein the integer n varies from 0 to N. The constant current D/A converter 40 receives the collector current of a transistor 15h serving as a constant current source and turns each of the constant current circuits to ON or OFF to generate a constant current corresponding to the data value. The generated constant current is added to the collector current of a transistor 15i driven by the full drive control portion 13 and is supplied to the coil 4a along with the collector current.

The optimum current control portion 12 of the present embodiment sets a current value outputted by the constant current D/A converter 40 so that the coil current Ir supplied to the coil 4a becomes optimal. The optimum current control portion 12 then outputs the data value corresponding to the set current value. For example, the optimum current control portion 12 may include the counter 12a and output the data value indicating a counter value stored by the counter 12a to the constant current D/A converter 40 through the data lines 41. Since the data value indicating the counter value corresponds to the current value to be outputted by the constant current D/A converter 40, the constant current D/A converter 40 outputs, on receiving the outputted data value, the current having the current value corresponding to the counter value indicated by the received data value.

As described above, the constant current D/A converter 40 may be constructed by the D/A converter 11 described in the first embodiment and the like and a part of the current switching circuit portion 15. In the relay drive circuit 1 having the constant current D/A converter 40 described above, when the optimum current control portion 12 outputs the data value corresponding to the counter value, the data value is directly translated by the constant current D/A converter 40. In the first embodiment or the like where the D/A converter 11 and the current switching circuit portion 15 are used, the signal outputted by the optimum current control portion 12 is transformed by the D/A converter 11 in a logical manner into the voltage signal for the operational amplifier 15a and in turn the voltage signal is transformed into the current signal by the operational amplifier 5a and the first transistor 15c. In the present embodiment, this complicated transformation is not necessary. Therefore it is possible to simplify the circuit configuration of the relay drive circuit 1.

In the present embodiment, the constant current D/A converter 40 and the transistors 15h and 15i serve not only as the current switching circuit portion 15 in the first embodiment or the like but also as the D/A converter 11. Therefore the constant current D/A converter 40 and the transistors 15h and 15i serve as a whole as the current switching portion, and the optimum current control portion 12 serves as the optimum current setting portion.

### Other Embodiments

The present invention should not be limited to the embodiment discussed above and shown in the figures, but may be implemented in various ways without departing from the spirit of the invention.

For example, in the first to third embodiments, the plate-OFF detecting portion 16 may detect, as the potential to be sensed, the difference of the potentials between both ends of the coil 4a in place of the potential at the low-side of the coil 4a. In the case of using the potential at the low-side of the coil 4a as the potential to be sensed, it is possible to detect the change of the Ir required value according to the change of the inductance of the coil 4a by monitoring just a single potential at a single point.

In the first to fourth embodiments, each of the D/A converter 11 and the optimum current control portion 12 is constructed as a single microcomputer, and the reference potential outputted by the D/A converter 11 is determined based on the counter value of the optimum current control portion 12. However, this is just an example. The D/A converter 11 and the optimum current control portion 12 may be replaced with any device such as a logic circuit if it can store the counter value indicating the reference potential outputted by the D/A converter 11.

In the fourth and fifth embodiments, the relay drive circuit 1 and the relay 4 can be commonly installed in the electric connection box 20 described in the third embodiment.

In the fifth embodiment, the relay 4 may be located at the low-side of the relay drive circuit 1, and the relay drive circuit 1 may drive the relay drive circuit 1 through the low-side of the relay 4.

What is claimed is:

1. A relay drive circuit for controlling, based on ON/OFF operation of a relay switch, power supply to a coil of an electromagnetic relay in order to control power supply to a load, the relay including the coil; a core inserted in the coil; a plate including magnetic material, the plate magnetically drawn to come in contact with a head of the core when the coil is supplied with electric power, the plate getting apart from the head when the coil is not supplied with electric power; a movable contact moving along with the plate; and a fixed contact installed to the coil, the relay drive circuit comprising:
a first drive portion for setting a coil current to be supplied to the coil to a first current value with which the plate is drawn to the head of the coil and the movable contact comes in contact with the fixed contact;
a second drive portion for setting the coil current to a second current value which is smaller than the first current value set by the first drive portion, so that the movable contact and the fixed contact are kept in contact with each other;
a current switching portion for switching between supplying the coil with the coil current having the first current value set by the first drive portion and supplying the coil with the coil current having the second current value set by the second drive portion; and
a plate-OFF detecting portion for detecting, based on change of a potential at an end of the coil, OFF-tendency in which the plate is about to get apart from the head of the coil,
wherein the current switching portion switches to supplying the coil with the coil current having the first current value set by the first drive portion, when the plate-OFF detecting portion detects the OFF-tendency.

2. The relay drive circuit according to claim 1 wherein,
the current switching portion is located at a low-side of the relay and drives the relay through the low-side, and
the plate-OFF detecting portion detects the OFF-tendency based on change of a potential at the low-side of the coil.

3. The relay drive circuit according to claim 2 wherein,
the plate-OFF detecting portion includes a highpass filter for passing only high frequency components in the potential at the low-side of the coil, and
the plate-OFF detecting portion detects the OFF-tendency when change of the high frequency components is larger than a threshold.

4. The relay drive circuit according to claim 1 wherein,
the current switching portion is located at a high-side of the relay and drives the relay through the high-side, and
the plate-OFF detecting portion detects the OFF-tendency based on change of a potential at the high-side of the coil.

5. The relay drive circuit according to claim 1, further comprising:
an optimum current setting portion for controlling the current switching portion so that the second current value becomes optimal,
wherein the optimum current setting portion sets, when the plate-OFF detecting portion detects the OFF-tendency while the coil current with the second current value is being supplied to the coil, a new value as the second current value which is larger than an old value set as the second current value before detection the OFF-tendency.

6. The relay drive circuit according to claim 5, wherein,
the current switching portion switches, when the relay switch is turned to ON, to supplying the coil with the coil current having the first current value so as to draw the plate so that the movable contact comes in contact with the fixed contact,
the current switching portion subsequently switches to supplying the coil with the coil current having the second current value,
the optimum current setting portion subsequently decreases the second current value gradually from an initial current value, and
the optimum current setting portion sets, on detecting the OFF-tendency in decreasing the second current value, the new value as the second current value which is larger than an old value which was the second current value at the time of the detection the OFF-tendency.

7. The relay drive circuit according to claim 5, wherein,
the current switching portion switches, when the plate-OFF detecting portion detects the OFF-tendency, to supplying the coil with the coil current having the first current value so as to draw the plate so that the movable contact comes in contact with the fixed contact,
the current switching portion subsequently switches to supplying the coil with the coil current having the second current value,
the optimum current setting portion subsequently decreases the second current value gradually from an initial current value, and
the optimum current setting portion sets, on detecting the OFF-tendency in decreasing the second current value, the new value as the second current value which is larger than the old value set as the second current value before the detection the OFF-tendency.

8. The relay drive circuit according to claim 5, wherein,
the optimum current setting portion includes:
a D/A converter for generating a potential corresponding to a counter value; and
an optimum current control portion for counting the counter value, and
the relay drive circuit changes the potential outputted by the D/A converter by changing the counter value of the optimum current control portion so as to decrease the current value of the coil current gradually from the first current value.

9. The relay drive circuit according to claim 5, wherein,
the optimum current setting portion includes an optimum current control portion including a counter for counting a counter value,
the current switching portion includes a constant current D/A converter for executing weighting based on the counter value so as to change a value of a current to output from the constant current D/A converter, and
the relay drive circuit changes the value of the current outputted by the constant current D/A converter by changing the counter value of the optimum current control portion so as to decrease the current value of the coil current gradually from the first current value.

10. An electric connection box for installing the relay drive circuit according to claim 1 and the relay cited in claim 1, comprising:
a wiring member to be electrically connected with the relay drive circuit and the relay;
a case in which the relay drive circuit and the relay is installed as well as the wiring member; and
an external connector terminal connected with the wiring member, the external connector terminal extended to an outside of the case.
